(19) United States
(12) Patent Application Publication
(10) Pub. No.: US 2004/0188859 A1
(43) Pub. Date: Sep. 30, 2004

(54) Filler compositions, apparatus, systems, and processes

(75) Inventor: Yi He, Gilbert, AZ (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/400,021

(22) Filed: Mar. 25, 2003

(51) Int. Cl. B29C 39/10; B29C 70/88; B29C 71/02

(52) U.S. Cl. 257/783; 264/236; 264/259; 264/272.11; 425/129.1

(57) ABSTRACT

A composition, apparatus, and system, as well as fabrication methods and processes therefor, may include a resin and a filler having a negative coefficient of thermal expansion.

### TECHNICAL FIELD

The subject matter relates generally to compositions, apparatus, systems, and processes used to ameliorate thermal expansion mismatch between various components, including dice and substrates.

### BACKGROUND INFORMATION

Electronic components, such as integrated circuits (ICs on dice), may be assembled into component packages by physically and electrically coupling them to a substrate made of organic or ceramic material. An IC may have a number of input/output, power, and ground terminals (also called “bumps” herein). An IC package substrate may have a number of metal layers selectively patterned to provide metal interconnect lines (also called “traces” herein), and a relatively large number of terminals (also called “pads” herein) to which the bumps of an IC can be suitably connected, for example, using solder.

An underfill encapsulant, a molding compound, or an underfill overmold compound (hereinafter “underfill”) may be used to mechanically and physically reinforce the solder joints used to couple IC bumps to substrate pads, which in turn may improve solder joint reliability. However, heat generated by the ICs, as well as ambient temperature, may cause reliability problems in the form of cracked bump-to-pad connections if the coefficient of thermal expansion (CTE) of the underfill is not substantially the same as the solder. Silica particle filler material may be added to the underfill in order to ameliorate the difference in CTE between the die and the substrate. However, the needed quantity of filler may significantly increase the underfill viscosity, making it more difficult to apply pre-cure. Large amounts of filler may also operate to increase the underfill modulus of elasticity post-cure. Thus, there is a significant need in the art for improving underfill performance.

### BRIEF DESCRIPTION OF THE DRAWINGS

FIG. 1 is a side cut-away view of a composition and an apparatus according to various embodiments;

FIG. 2 is a side cut-away view of an apparatus and a system according to various embodiments;

FIG. 3 is a flow chart illustrating several processes according to various embodiments; and

FIG. 4 is a block diagram of an article according to various embodiments.

### DETAILED DESCRIPTION

In the following detailed description of various embodiments, reference is made to the accompanying drawings that form a part hereof, and in which are shown by way of illustration, and not of limitation, specific embodiments in which the subject matter may be practiced. In the drawings, like numerals describe substantially similar components throughout the several views. The embodiments illustrated are described in sufficient detail to enable those skilled in the art to practice the teachings disclosed herein. Other embodiments may be utilized and derived therefrom, such that compositional, structural, and logical substitutions and changes may be made without departing from the scope of this disclosure. The following detailed description, therefore, is not to be taken in a limiting sense.

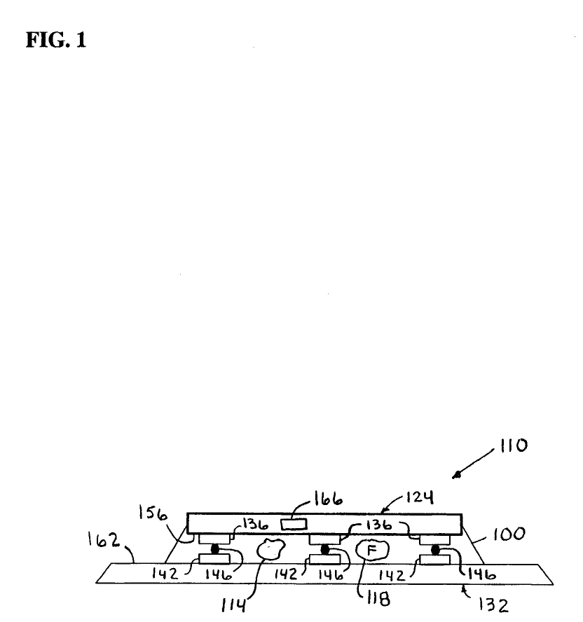

FIG. 1 is a side cut-away view of a composition 100 and an apparatus 110 according to various embodiments, in which a composition 100 may comprise a variety of materials 114, including a resin, and a filler 118 having a negative CTE. For example, the filler 118 may comprise an oxide, such as an inorganic or metal oxide, including a metal oxide having a trivalent cation. Thus, an underfill composition 100 may be formed by supplementing or replacing a conventional silicon dioxide (i.e., SiO₂) filler with an inorganic oxide having a negative CTE.

At least two advantages may accrue. First, assuming the same filler content is used by weight, the resulting underfill 100 may have a lower CTE, which further reduces the CTE mismatch and the induced thermal stress in an associated package. Second, to achieve the same reduction in CTE as can be achieved with conventional fillers, less filler 118 having a negative CTE may be needed, improving the flow properties of the underfill 100, since increasing the amount of filler may provide higher viscosity and longer flow time or shorter flow distance under the same processing conditions.

Negative CTE fillers 118 include metal oxides in which the chemical bonding between the metal and oxygen is very strong. Such materials include, but are not limited to: ZrW₂O₈, ZrV₂O₇, ZrV₂₋ₓPₓO₇, Y₂W₃O₁₂, Sc₂W₃O₁₂, Lu₂W₃O₁₂ (e.g., members of the A₂M₃O₁₂ family where A is a trivalent cation ranging from Al to some rare earths, and M is W or Mo). The negative CTE of such materials may exist over a wide temperature range. For example, ZrW₂O₈, which has a cubic structure and is isotropic in its thermal expansion property, has a negative CTE over its entire stability range of about 0.3 to about 1050 K. At room temperature, its CTE is about −8.7×10⁻⁶ K⁻¹.

It is possible to estimate the CTE for underfill using only conventional SiO₂ fillers, versus the CTE for an underfill 100 having fillers 118 with a negative CTE. For the following example, ZrW₂O₈ will be considered as a negative CTE filler 118. According to R. M. Christensen (“Mechanics of Composite Materials” by R. M. Christensen, p. 324, 1979), the effective CTE of a composite material may be given by the formula:

$$α = {α}_{m} + \frac{{α}_{i} - {α}_{m}}{\frac{1}{{k}_{i}} - \frac{1}{{k}_{m}}} ( \frac{1}{k} - \frac{1}{{k}_{m}} ) ,$$

wherein α is the CTE of a composite (i.e., the underfill, including a filler), αₘ is the CTE of a polymer matrix, αᵢ is the CTE of the filler, k is the bulk modulus of the composite (i.e., the underfill, including a filler), kₘ is the bulk modulus of the matrix and kᵢ is the bulk modulus of the filler. For an underfill-type composite system, kᵢ>>kₘ, >>kₘ, thus the above equation can be reduced to:

$$α \approx {α}_{m} - ( {α}_{i} - {α}_{m} ) ( \frac{{k}_{m}}{k} - 1 ) .$$

To compare the CTE of an underfill containing about 65% SiO₂ filler and an underfill 100 containing the same amount of ZrW₂O₈ filler 118, assume the polymer matrix has a CTE of about 90×10⁻⁶ K⁻¹ at room temperature, and that an underfill with no filler has a room temperature Young's modulus Eₘ of about 2 GPa. Also, assume that the CTE of SiO₂ at room temperature is about 0.55×10⁻⁶ K⁻¹. Then, for an underfill with about 65% SiO₂ filler, the modulus E is about 8 GPa. To a first order of approximation, kₘ/k is about the same as Eₘ/E, which is about 0.25 for the exemplary system. Then, for a conventional underfill where SiO₂ filler is used alone, α(10⁻⁶ K⁻¹)=90−(0.55−90)(0.25−1)=23. Assuming that the same kₘ/k ratio holds for an underfill 100 in which ZrW₂O₈ filler 118 is used in place of the SiO₂ filler, α(10⁻⁶ K⁻¹)=90−(−8.7−90)(0.25−1)=16, which is about 30% less than the CTE attained when only conventional SiO₂ filler is used. Such a reduction in CTE may provide a corresponding percentage reduction in package thermal stress.

In some embodiments, it may be desirable that the filler 118 comprise a sufficient amount by weight of the underfill composition 100 so that the composition 100 has a CTE that is substantially the same as the CTE of an electrically conductive material, such as an adhesive paste (e.g., conductive epoxy), or solder. Alternatively, or in addition, it may be desirable that the filler 118 comprises a sufficient amount by weight of the composition 100 so that the composition 100 has a CTE that is substantially the same as the CTE of a silicon material, and/or other material included in a substrate.

The phrase “sufficient amount” as used herein identifies an amount of filler 118 sufficient to obtain the desired performance from the underfill 100, e.g., obtaining a desired or targeted CTE for the underfill composition 100 according to various embodiments. Thus, for example, a sufficient amount of filler 118 in the underfill composition 100 may be an amount that results in achieving a CTE for the composition 100 that substantially matches the CTE for a selected substrate (e.g., 20 ppm/° C.), or that substantially matches the CTE for solder (e.g., 25 ppm/° C.). In some embodiments, the CTE of the composition 100 may be about 5×10⁻⁶ K⁻¹ to about 75×10⁻⁶ K⁻¹ at room temperature, or a temperature of about 25° C.

Thus, in some embodiments, a sufficient amount of the filler 118 may comprise about 10% to about 95% by weight of the underfill composition 100. As noted above, the composition 100 may comprise a variety of materials, including one or more additive materials 114, including but not limited to an elastomer, a hardener, a catalyst, a reactive diluent, an adhesion promoter, a surfactant, a deforming agent, a fluxing agent, a toughening agent, and/or a coupling agent. The underfill composition 100 may also include materials 114, such as a resin, which may comprise an epoxy resin, which may in turn include a hardener and a coupling agent.

Other embodiments may also be realized. For example, as shown in FIG. 1, some embodiments include an apparatus 110 comprising a die 124 and a substrate 132 coupled to the die 124 using a composition 100 comprising a resin 114, and a filler 118 having a negative CTE. The die 124 may comprise any number of circuitry and/or components, including a flip-chip. The apparatus 110 may also comprise a plurality of terminals 136 (e.g., bumps) on the die 124 coupled to a corresponding plurality of terminals 142 (e.g., pads) on the substrate 132 using an electrically conductive material 146.

The substrate 132 may comprise organic or inorganic materials, or combinations of these. The substrate 132 may also comprise flexible materials and/or nonflexible materials. The materials included in the substrate 132 may be non-conductive or conductive, depending upon the configuration and requirements of the apparatus 110.

The terminals 136, 142 can be located on a surface 156, 162 of the substrate 132 and/or die 124, respectively, and/or embedded within the substrate 132 and/or die 124, respectively. Thus, the terminals 136, 142 may be etched out of a conductive material coupled to the die 124 and/or the substrate 132, or deposited thereon and coupled by any number of methods including, for example, soldering, staking, insert molding, friction fit, conductive epoxy, etc. For example, the substrate 132 could be fabricated from single-sided, double-sided, or multiple layers of FR4 (Fire Retardant Grade 4) circuit board material with copper conductors 142, the conductor size and number depending upon the power requirements of circuitry 166 (e.g, a processor and/or memory) included in the die 124. The terminals 136, 142 may be used to conduct any form of energy included in the electromagnetic spectrum.

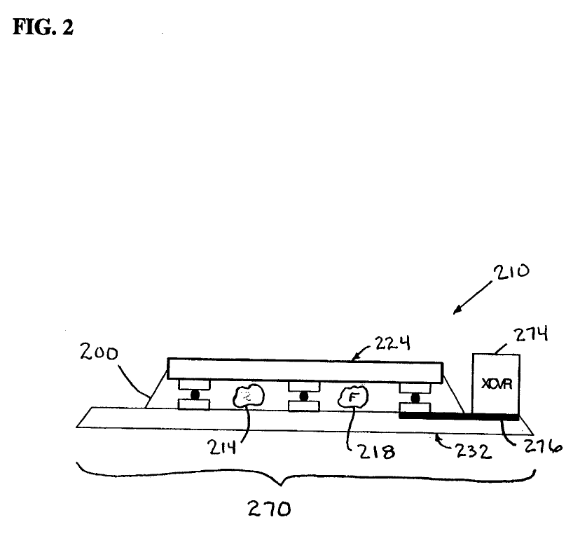

Still other embodiments may be realized. For example, FIG. 2 is a side cut-away view of an apparatus 210 and a system 270 according to various embodiments, wherein a system 270 may comprise a wireless transceiver 274 electrically coupled to a die 224. The system 270 may also comprise a substrate 232 coupled to the die 224 using a composition 200 comprising a material 214, which may comprise a resin, and a filler 218 having a negative coefficient of thermal expansion. As noted above, the filler 218 may comprise an organic or an inorganic material. The die 224 may be electrically coupled to the wireless transceiver 274 using an electrically conductive material, including an electrically conductive lead-free (i.e., Pb-free) material 276, such as a Pb-free adhesive paste (e.g., conductive epoxy), or Pb-free solder.

Referring now to FIGS. 1 and 2, it should be noted that the materials 114, 214 (e.g., a resin) and filler 118, 218 are shown as discrete components of the composition 100, 200, respectively. This method of illustration is used so as not to obscure the makeup of the composition 100, 200, but is not meant to limit the use, appearance, form, or combinational mechanisms of the materials 114, 214 and filler 118, 218 within the composition 100, 200 in any way. Thus, for example, the materials 114, 214 and filler 118, 218 may be physically intermixed with each other and with other components of the composition 100, 200 so as to be readily distinguishable from each other. It is also possible that the materials 114, 214 and filler 118, 218 are so combined with each other and/or other components of the composition 100, 200 as to be physically indistinguishable from each other and/or the other components within the composition 100, 200 (e.g., a chemical analysis, rather than a microscopic examination of the composition 100, 200 may be required to determine the presence of the materials 114, 214 and/or the filler 118, 218 within the composition 100, 200). Finally, it may also be the case that the materials 114, 214 and filler 118, 218 are so combined or bonded with each other and/or other components of the composition 100, 200 as to be chemically indistinguishable from each other and/or the other components within the composition 100, 200 after the composition 100, 200 is formed.

The composition 100, 200, apparatus 110, 210, materials 114, 214, filler 118, 218, die 124, 224, substrate 132, 232, terminals 136, 142, electrically conductive material 146, 276, surfaces 156, 162, circuitry 166, system 270, and wireless transceiver 274 may all be characterized as “modules” herein. Such modules may include hardware circuitry, and/or a processor and/or memory circuits, software program modules and objects, and/or firmware, and combinations thereof, as desired by the architect of the composition 100, 200, apparatus 110, 210, and system 270, and as appropriate for particular implementations of various embodiments. For example, such modules may be included in a system operations simulation package, such as a software electrical signal simulation package, a power usage and distribution simulation package, a thermo-mechanical stress simulation package, a power/heat dissipation simulation package, and/or a combination of software and hardware used to simulate the operation of various potential embodiments.

It should also be understood that the compositions, apparatus, and systems of various embodiments can be used in applications other than for reducing stress between dice coupled to substrates, and thus, these embodiments are not to be so limited. The illustrations of a composition 100, 200, apparatus 110, 210, and a system 270 are intended to provide a general understanding of the elements and structure of various embodiments, and they are not intended to serve as a complete description of all the features of compositions, apparatus, and systems that might make use of the elements and structures described herein.

Applications that may include the novel compositions, apparatus, and systems of various embodiments include electronic circuitry used in high-speed computers, communication and signal processing circuitry, data transceivers, modems, processor modules, embedded processors, and application-specific modules, including multilayer, multi-chip modules. Such compositions, apparatus, and systems may further be included as sub-components within a variety of electronic systems, such as televisions, cellular telephones, personal computers, workstations, radios, video players, vehicles, and others.

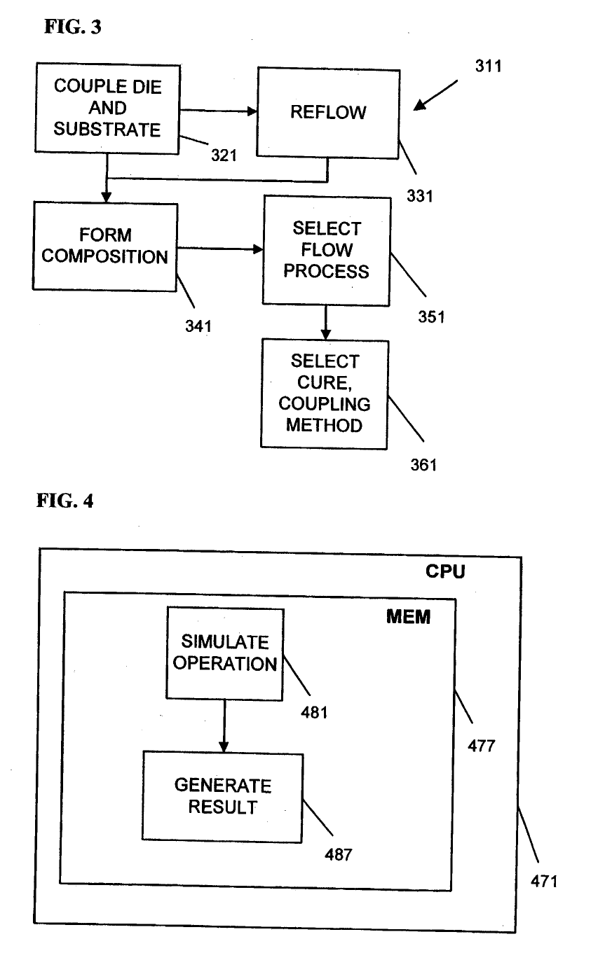

Some embodiments include a number of methods. For example, FIG. 3 is a flow chart illustrating a process 311 according to various embodiments. A process 311 may include coupling a die and a substrate at block 321 using a number of mechanisms. Such mechanisms may include coupling the die and substrate using one or more solder bumps, such as by reflowing the solder bumps at block 331. Alternatively, or in addition, the die and the substrate may be coupled by curing a composition formed between them using one or more processes selected from autocatalytic curing, additive catalytic curing, cross-linking, and thermoset (see block 361, described below).

The process 311 may thus include forming (e.g. by placing, providing, and/or depositing) a composition between the die and the substrate at block 341, the composition comprising a resin, and a filler having a negative CTE. For example, forming the composition at block 341 may comprise selecting one or more processes, including no-flow, capillary flow, and capillary-assisted flow processes, at block 351. The process 311 may further include curing the composition by any number of methods, including one or more processes selected from autocatalytic curing, additive catalytic curing, cross-linking, and thermoset at block 361. Thus, as noted above, the die and the substrate may also be coupled using a number of mechanisms, including a solder bump, such as by reflowing the solder bump (at block 331). Alternatively, or in addition, the die and the substrate may be coupled by curing the composition using one or more processes selected from autocatalytic curing, additive catalytic curing, cross-linking, and thermoset (at block 361).

It should be noted that the processes described herein do not have to be executed in the order described, or in any particular order. Moreover, various activities described with respect to the processes identified herein can be executed in serial or parallel fashion.

FIG. 4 is a block diagram of an article 471 according to various embodiments. Thus, another embodiment may include an article 471, such as a computer, a memory system, a magnetic or optical disk, some other storage device, and/or any type of electronic device or system, comprising a machine-accessible medium such as a memory 477 (e.g., a memory including an electrical, optical, or electromagnetic conductor) having associated data 481, 487 (e.g., computer program instructions), which when accessed, results in a machine performing such actions as simulating the behavior of a die coupled to a substrate by a composition comprising a resin, and a filler having a negative CTE, and generating a human-perceivable result of the simulating.

As noted above, the die may comprise any number of circuits, including a processor and/or memory. The result may include an analysis of the CTE for the composition and the CTE for the substrate. The result may also include an analysis of the CTE of the composition and the CTE of an electrically conductive material (e.g., solder) used to couple the die and the substrate. Further actions may include displaying a result of the simulation using a human-perceivable medium, such as a video display, or hardcopy printout.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

What is claimed is:

1. A composition, comprising:
a resin; and
a filler having a negative coefficient of thermal expansion.

2. The composition of claim 1, wherein the filler comprises an oxide.

3. The composition of claim 1, wherein the filler comprises a metal oxide.

4. The composition of claim 3, wherein the metal oxide includes a trivalent cation.

5. The composition of claim 1, wherein the filler comprises about 10% to about 95% by weight of the composition.

6. The composition of claim 1, further comprising:
at least one additive material selected from an elastomer, a hardener, a catalyst, a reactive diluent, an adhesion promoter, a surfactant, a deforming agent, a fluxing agent, a toughening agent, and a coupling agent.

7. The composition of claim 1, wherein the resin comprises an epoxy resin, further comprising:
a hardener; and
a coupling agent.

8. The composition of claim 1, wherein the filler comprises a sufficient amount by weight of the composition so that the composition has a coefficient of thermal expansion that is substantially the same as a coefficient of thermal expansion of an electrically conductive material.

9. The composition of claim 1, wherein the filler comprises a sufficient amount by weight of the composition so that the composition has a coefficient of thermal expansion that is substantially the same as a coefficient of thermal expansion of a silicon material.

10. An apparatus, comprising:
a die; and
a substrate coupled to the die using a composition comprising a resin and a filler having a negative coefficient of thermal expansion.

11. The apparatus of claim 10, further comprising:
a plurality of terminals on the die coupled to a corresponding plurality of terminals on the substrate using an electrically conductive material.

12. The apparatus of claim 10, wherein the die comprises a flip-chip.

13. The apparatus of claim 10, wherein a total coefficient of thermal expansion of the composition is about 5×10⁻⁶ K⁻¹ to about 75×10⁻⁶ K⁻¹ at a temperature of about 25 C.

14. The apparatus of claim 10, wherein the substrate comprises an organic material.

15. A system, comprising:
a wireless transceiver;
a die electrically coupled to the wireless transceiver; and
a substrate coupled to the die using a composition comprising a resin and a filler having a negative coefficient of thermal expansion.

16. The system of claim 15, wherein the filler comprises an inorganic material.

17. The system of claim 15, wherein the die is electrically coupled to the wireless transceiver using an electrically conductive Pb-free material.

18. A process, comprising:
forming a composition between a die and a substrate, the composition comprising a resin and a filler having a negative coefficient of thermal expansion.

19. The process of claim 18, wherein forming the composition comprises a process selected from no-flow, capillary flow, and capillary-assisted flow.

20. The process of claim 18, further comprising:
curing the composition by at least one process selected from autocatalytic curing, additive catalytic curing, cross-linking, and thermoset.

21. The process of claim 18, wherein the die and the substrate are coupled with a solder bump, further comprising:
reflowing the solder bump.

22. The process of claim 18, wherein the die and the substrate are coupled with a solder bump, further comprising:
curing the composition by at least one process selected from autocatalytic curing, additive catalytic curing, cross-linking, and thermoset; and
reflowing the solder bump.

23. An article comprising a machine-accessible medium having associated data,
wherein the data, when accessed, results in a machine performing:
simulating a behavior of a die coupled to a substrate by a composition comprising a resin and a filler having a negative coefficient of thermal expansion; and
generating a human-perceivable result of the simulating.

24. The article of claim 23, wherein the die comprises a processor.

25. The article of claim 23, wherein the result includes an analysis of a coefficient of thermal expansion of the composition and a coefficient of thermal expansion of the substrate.

26. The article of claim 23, wherein the result includes an analysis of a coefficient of thermal expansion of the composition and a coefficient of thermal expansion of an electrically conductive material used to couple the die and the substrate.
